(19) United States
(12) Patent Application Publication
(10) Pub. No.: US 2011/0274026 A1
(43) Pub. Date: Nov. 10, 2011

(54) METHOD FOR ALLOWING TRANSPARENT TRANSMISSION AND NON-TRANSPARENT TRANSMISSION OF RELAY NODE TO COEXIST

(76) Inventors: Lei Huang, Shanghai (CN); Renmao Liu, Shanghai (CN); Yingyu Zhang, Shanghai (CN); Ming Ding, Shanghai (CN); Chen Chen, Shanghai (CN); Guolin Sun, Shanghai (CN)

(21) Appl. No.: 13/143,174

(22) PCT Filed: Dec. 28, 2009
(86) PCT No.: PCT/JP2009/007343

§ 371 Date: Jul. 1, 2011

(30) Foreign Application Priority Data
Jan. 4, 2009 (CN) 200910002328.6

(51) Int. Cl. H04W 88/04; H04W 72/04

(52) U.S. Cl. 370/312; 370/315

(57) ABSTRACT

The present invention provides a method for allowing transparent transmission and non-transparent transmission of a relay node to coexist. That is, a frequency-division multiplex system is employed so that a transparent transmission mode is used in one operating carrier frequency bandwidth whereas a non-transparent transmission mode is used in another operating carrier frequency bandwidth. In addition, according to the frequency-division multiplex system, the transparent transmission mode is used for a plurality of subframes whereas the non-transparent transmission mode is used for another plurality of subframes. The method for allowing transparent transmission and non-transparent transmission of a relay node to coexist makes it possible to effectively reduce a cost of a system.

### TECHNICAL FIELD

The present invention relates to a field of mobile communication technologies, specifically, relates to a design of transparent relay in an LTE-Advanced system, a design of coexistence of transparent relay and non-transparent relay, and a method for the LTE-Advanced system to realize compatibility with an LTE user apparatus via a relay node.

### BACKGROUND ART

A latest standardization document “TR36.814” of 3GPP (R1-084256, 3GPP TR 36.814 v0.1.1, 3GPP TSG RAN Further Advancements for E-UTRA Physical Layer Aspects, Sep, 2008) explains a function of a relay node (also referred to as relay station) of an LTE-Advanced (Long Term Evolution-Advanced) system. According to TR36.814, a relay node is classified into the following two types, in accordance with information that a user apparatus obtains. One type is a transparent relay node. In a case where the user apparatu is connected with a network via the transparent relay node, the user apparatus cannot recognize the transparent relay node. Another type is a non-transparent relay node. In a case where the user apparatus is connected with the network via the non-transparent relay node, the user apparatus can recognize the non-transparent relay node. Depending on a method of a relay node, the relay node can be a part of a cell. In this case, the relay node appropriately supports the LTE (Long Term Evolution) user apparatus. An intelligent relay node, a decode transfer relay node, and other layer-2 relay nodes all belong to this kind of relay nodes. A relay node can also control its cell (i.e., area that the relay node covers). Each of relay nodes has one unique physical layer cell ID so as to control its cell. There is no big difference between access from a cell controlled by a relay node to the user apparatus and access from a cell controlled by a base station (eNB) to the user apparatus. The cell controlled by the relay node should also support the LTE user apparatus. Layer-3 relay nodes belong to this kind of relay nodes.

A proposal (R1-083866, More design aspects on downlink transparent relay in LTE-A, Nortel, 3GPP RANI #54 bis, Sep. 29-Oct. 3, 2008) in a 3GPP TSG RAN WG1 54 bis meeting at Nortel Networks Co., Ltd. states that it is necessary to support a transparent relay node type and a non-transparent relay node type together in an LTE-Advanced system. A transparent relay node is simple and has no special requirement related to a user apparatus. Therefore, the transparent relay node is suitable for supporting an LTE user apparatus in an LTE network or an LTE-Advanced network. In contrast, a non-transparent relay node has more functions than the transparent relay node has. Therefore, the non-transparent relay node can be utilized in supporting a more progressive LTE-Advanced user apparatus.

The transparent relay node type and the non-transparent relay node type are thus complementary to each other. Therefore, even if the transparent relay node and the non-transparent relay node are employed together in an LTE-Advanced system, no conflict is caused. The transparent relay node and the non-transparent relay node can coexist at one placement point. This indicates that no unnecessary overhead is required in supporting the transparent relay node and the non-transparent relay node.

A relay node has such a characteristic that the relay node cannot transmit data while receiving data, and in other situations, the relay node inevitably takes in an intense interference. In this case, a problem to be solved is how a good compatibility between the relay node and the LTE user apparatus can be achieved. In a 3GPP TSG RAN WG1 55^{th} meeting, TSG-RAN WG1 presented LS (R1-084538, LS on forward compatibility support in Rel-8, 3GPP RAN1 #55, 10-14 Nov, 2008) to TSG-RAN WG2 and TSG-RAN WG4. In RAN 1, a problem of upward compatibility between a relay node and an LTE user apparatus in an LTE-Advanced system was discussed, and an agreement was reached. That is, the problem is solved by use of an extended MBSFN (MBMS Single Frequency Network) subframe allocation method of MBMS (Multimedia Broadcast and Multicast Service). This extension allows noncontiguous allocation of MBSFN subframes. In accordance with this, it is necessary to change an arrangement of MBSFN in order to instruct, with a more flexible signal, where to locate subframes for normal data communication and the MBSFN subframes for MBMS.

Icera Inc. stated as below in a proposal (R1-084436, Operation of Relay Nodes for LTE-Advanced, Icera Semiconductor, 3GPP RANI #55, 10-14 Nov, 2008) presented in the 3GPP TSG RAN WG1 55^{th} meeting. A user apparatus cannot distinguish whether user data has been transmitted from a base station beyond a transparent relay node in a layer 2 or from a relay node beyond the transparent relay node. Further, a relay node operates on the basis of scheduling information transmitted from the base station. A transparent relay node uses a cell number (cell physical ID) which is identical to that of the base station so as to transmit synchronization information for identical pieces of broadcast information. Accordingly, there is no need to add, with consideration for relay nodes, mechanisms such as another reference signal, measurement, transmitting power control, and HARQ (Hybrid Automatic Repeat request) to a system. The transparent relay node in the layer 2 can expand a network cover range of the LTE user apparatus. Further, a relay node decodes user data received from a base station so as to retransmit the user data to a non-transparent relay node the layer 2 in a different method. This indicates that one non-transparent relay node can carry out a simple scheduling function and a link adaptation function, and also transmit its own reference signal. In this case, the user apparatus needs to know that the user data has been transmitted from the relay node.

Samsung pointed out, in R1-083568, that displacement, which corresponds to one subframe, between a base station and a relay node is used to solve the problem of interference of a layer-3 relay node, and the problem of upward compatibility is solved by adopting a method utilizing displacement between two OFDM (Orthogonal Frequency Division Multiplexing) symbols (hereinafter, simply referred to as symbols).

### Citation List

Non-patent Literature 1

R1-084256, 3GPP TR 36.814 v0.1.1, 3GPP TSG RAN Further Advancements for E-UTRA Physical Layer Aspects, Sep, 2008

Non-patent Literature 2

R1-083866, More design aspects on downlink transparent relay in LTE-A, Nortel, 3GPP RANI #54 bis, Sep. 29-Oct 3, 2008

Non-patent Literature 3

R1-084538, LS on forward compatibility support in Rel-8,

Non-patent Literature 4

R1-084436, Operation of Relay Nodes for LTE-Advanced, Icera Semiconductor, 3GPP RAN1 #55, 10-14 Nov, 2008

Non-patent Literature 5

R1-083568, Discussion on L3 Relay for LTE-A, Samsung, 3GPP RANI #54 bis, Sep. 29-Oct. 3, 2008

### SUMMARY OF INVENTION

### Technical Problem

As described above, pointed out are advantage and disadvantage of each of the transparent relay and the non-transparent relay of the proposals above. However, no concrete solution is shown.

In order to solve the problems of the conventional techniques, the present invention provides a method for designing a relay node, and a method for one relay node to transmit data to an LTE user apparatus in a transparent mode and transmit data to an LTE-Advanced user apparatus in a non-transparent mode.

That is, an object of the present invention is to provide a method for allowing transparent transmission and non-transparent transmission of a relay node to coexist in an LTE-Advanced system having a relay node, in order to effectively realize, by transparent relay, upward compatibility with the LTE user apparatus in the LTE-Advanced system, and to provide a service to the LTE-Advanced user apparatus by non-transparent relay.

### Solution to Problem

The present invention makes it possible to concretely realize, in accordance with the object of the present invention, such advantage and/or other advantage by the following method for allowing transparent transmission and non-transparent transmission to coexist in a relay enhanced LTE-Advanced system.

In order to attain the object, a method, according to a first method of the present invention, for allowing transparent transmission and non-transparent transmission of a relay node to coexist, includes the steps of: causing a base station apparatus to (i) schedule and arrange a carrier frequency bandwidth in which a relay node operates in a transparent mode and (ii) transmit subframe assignment information to the relay node via an upper layer signal; causing the base station apparatus to (i) schedule all relay user apparatuses to be connected with the relay node and (ii) transmit service information and control information of all the relay user apparatuses thus scheduled, to the relay node, in a relay subframe in one carrier frequency bandwidth or in a plurality of carrier frequency bandwidths, by unicast or multicast; causing the relay node to transmit data to an LTE relay user apparatus or an LTE-Advanced relay user apparatus in the carrier frequency bandwidth in which the relay node operates in the transparent mode; and causing the relay node to transmit data to the LTE-Advanced relay user apparatus in a carrier frequency bandwidth in which the relay node operates in a non-transparent mode.

Further, the method is preferably arranged such that carrier frequency bandwidths in which relay nodes in a cell of the base station apparatus operate in the transparent mode are perpendicular to each other.

Further, the method preferably further includes the steps of: setting a number of a subframe of the base station apparatus and a number of a subframe of the relay node so that displacement corresponding to an integer is caused between the subframe of the base station apparatus and the subframe of the relay node; and causing the base station apparatus and the relay node to use all resource in the cell in a multiplexed manner.

In order to attain the object, a method, according to a second method of the present invention, for allowing transparent transmission and non-transparent transmission of a relay node to coexist, includes the steps of: causing a base station apparatus to (i) schedule a subframe to be transmitted by a relay node in a transparent mode and a subframe to be transmitted by the relay node in a non-transparent mode and (ii) transmits information on such subframe scheduling to a relay user apparatus via an upper layer signal; causing the base station apparatus to schedule all relay user apparatuses to be connected with the relay node and transmit, in a relay subframe, service information and control information of all the relay user apparatuses thus scheduled to the relay node by unicast or multicast; causing the relay node to transmit, in a non-transparent subframe, data to an LTE-Advanced relay user apparatus by a non-transparent method; and causing the relay node to transmit, in a transparent subframe, data to an LTE relay user apparatus or the LTE-Advanced relay user apparatus by a transparent method.

Further, the method is preferably arranged such that carrier frequency bandwidths in which relay nodes in a cell of the base station apparatus operate in the transparent mode are perpendicular to each other.

In order to attain the object, a method, according to a third method of the present invention, for a relay node to transmit data by a transparent method, includes the step of causing all relay nodes to transmit, in respective non-relay subframes, identical data information to one relay user apparatus by use of resource blocks which are identical in time and frequency.

Further, the method preferably further includes the step of causing a base station apparatus and all relay nodes to transmit, in respective non-relay subframes, identical data information to one relay user apparatus by use of resource blocks which are identical in time and frequency.

Further, the method is preferably arranged such that in a current non-relay subframe, time-frequency resource blocks which are scheduled to be transferred to respective different relay user apparatuses are perpendicular to each other.

In order to attain the object, a method, according to a fourth method of the present invention, for a relay node to transmit data by a transparent method, includes the steps of: causing a base station apparatus to set, in accordance with an upper layer signal, identical resource scheduling subband sets for relay user apparatuses which connect to one relay node; causing all relay nodes to (i) transmit, in control information regions of non-relay subframes, identical control information to one relay user apparatus by use of resource blocks which are identical in time and frequency and transmit (ii) a common reference signal to the one relay user apparatus across an entire system frequency bandwidth; and causing each of the relay nodes to transmit, in a data information region of a corresponding one of the non-relay subframes, a common reference signal, a specialized reference signal, and corresponding data information to a corresponding relay user apparatus, in a resource scheduling subband set corresponding to the corresponding relay user apparatus.

Further, the method preferably further includes the step of causing relay user apparatuses to operate in a transmission mode 7 so as to demodulate data by use of a specialized reference signal applied to a predetermined antenna port.

Further, the method is preferably arranged such that in a data information region of a corresponding one of the non-relay subframes, each of the relay nodes does not transmit any common reference signal to a corresponding relay user apparatus in any subband except a resource scheduling subband set corresponding to the corresponding relay user apparatus.

In order to attain the object, a method, according to a fifth method of the present invention, for a relay node to transmit data by a transparent method, includes the steps of: causing a base station apparatus to set, in accordance with an upper layer signal, identical resource scheduling subband sets for relay user apparatuses which connect to one relay node; causing a base station apparatus to set, in accordance with an upper layer signal, identical resource scheduling subband sets for directly-connected relay user apparatuses which connect to the base station apparatus; causing the base station apparatus and all relay nodes to (i) transmit, in control information regions of non-relay subframes, identical control information to one relay user apparatus by use of resource blocks which are identical in time and frequency and transmit (ii) a common reference signal to the one relay user apparatus across an entire system frequency bandwidth; and causing each of base station apparatus and the relay nodes to transmit, in a data information region of a corresponding one of the non-relay subframes, a common reference signal, a specialized reference signal, and corresponding data information to a corresponding relay user apparatus, in a resource scheduling subband set corresponding to the corresponding relay user apparatus.

Further, the method preferably further includes the step of causing the directly-connected relay user apparatus and the relay user apparatuses to operate in a single-antenna mode so as to demodulate data by use of a specialized reference signal applied to a predetermined antenna port.

Further, the method is preferably arranged such that in a data information region of a corresponding one of the non-relay subframes, each of the base station apparatus and the relay nodes does not transmit any data information to a corresponding relay user apparatus in any subband except a resource scheduling subband set corresponding to the corresponding relay user apparatus.

Further, the method is preferably arranged such that in a data information region of a corresponding one of the non-relay subframes, each of the base station apparatus and the relay nodes does not transmit any common reference signal to a corresponding relay user apparatus in any subband except a resource scheduling subband set corresponding to the corresponding relay user apparatus.

In order to attain the object, a method, according to sixth method of the present invention, for a relay node to transmit data by a transparent method, comprising the step of causing relay nodes to transmit, at respective different carrier frequencies, data information to respective corresponding relay user apparatuses.

Further, the method preferably further includes the step of causing the base station apparatus and the relay nodes to transmit, at respective different carrier frequencies, data information to respective corresponding relay user apparatuses.

In order to attain the object, a method, according to a seventh method of the present invention, for a relay user apparatus to carry out a cell search process, includes the steps of: detecting a carrier frequency of a system; detecting a primary synchronization signal in a time domain so as to realize synchronization between symbols; obtaining, in the time domain, a sector number on the basis of a sequence of the primary synchronization signal; detecting, in the time domain, a sequence signal indicative of a physical ID of a relay node; determining, in the time domain, a type of the relay node on the basis of a sequence of the sequence signal thus detected, in such a manner that if the sequence is a predetermined special sequence, the relay node is determined to be a transparent relay node or a base station apparatus, and if the sequence is a non-special sequence, the relay node is determined to be a non-transparent relay node; obtaining in the time domain if the relay node has been determine to be a non-transparent relay node, a number indicated by a non-transparent relay node physical ID, on the basis of the sequence; obtaining, in the time domain, a sub-synchronization signal so as to realize synchronization between frames; obtaining, in the time domain, a cell group number on the basis of a sequence of the sub-synchronization signal thus detected; determining a physical ID of a cell or the relay node in accordance with the type of the relay node; detecting a reference signal of the relay node on the basis of the physical ID of the cell or the relay node; and ending a cell search process so as to start a process of detecting system broadcast information.

In order to attain the object, a method, according to an eighth method of the present invention, for a relay user apparatus to carry out a cell search process, includes the steps of: detecting a carrier frequency of a system; detecting a primary synchronization signal in a time domain so as to realize synchronization between symbols; obtaining, in the time domain, a sector number on the basis of a sequence of the primary synchronization signal; detecting, in the time domain, a sub-synchronization signal so as to realize synchronization between frames; obtaining, in the time domain, a cell group number on the basis of a sequence of the sub-synchronization signal thus detected; carrying out channel estimation on the basis of the sub-synchronization signal thus detected; carrying out, on the basis of a result of the channel estimation, data demodulation of content of a symbol which is followed by a symbol containing the sub-synchronization signal; reading a type bit of a relay node so as to determine a type of the relay node; reading, if the type of the relay node is a non-transparent relay type, bit information indicative of a relay node physical ID; obtaining an index number if the type of the relay node is the non-transparent relay type; obtaining other related system information if the type of the relay node is the non-transparent relay type; determining a physical ID of a cell or the relay node in accordance with the type of the relay node; detecting a reference signal of the relay node on the basis of the physical ID of the cell or the relay node; and ending a cell search process so as to start a process of detecting system broadcast information.

In order to attain the object, a method, according to a ninth method of the present invention, for a relay user apparatus to carry out a cell search process, includes the steps of: detecting a carrier frequency of a system; detecting a primary synchronization signal in a time domain so as to realize synchronization between symbols; obtaining, in the time domain, a sector number on the basis of a sequence of the primary synchronization signal; determining, if the sequence of the primary synchronization signal is one of three sequences defined by the LTE standard which three sequences are used in transmission of the primary synchronization signal, that a node is a transparent relay node or a base station apparatus; determining, if the sequence of the primary synchronization signal is none of the three sequences defined by the LTE standard which three sequences are used in transmission of the primary synchronization signal, that the node is a non-transparent relay node; detecting, in the time domain, a sub-synchronization signal so as to realize synchronization between frames; obtaining, in the time domain, a cell group number on the basis of a sequence of the sub-synchronization signal thus detected; determining a physical ID of a cell or a relay node in accordance with the type of the node; detecting a reference signal of the node on the basis of the physical ID of the cell or the relay node; and ending a cell search process so as to start a process of detecting system broadcast information.

### Advantageous Effects of Invention

According to the methods of the present invention, one relay node can transparently provide a service to an LTE user apparatus and non-transparently provide a service to an LTE-Advanced user apparatus. This makes it possible to realize a good upper compatibility of an LTE-Advanced system and to improve, for the LTE-Advanced user apparatus, a system performance through the introduction of a new design. The methods of the present invention allow flexible design and reduction in system cost.

### BRIEF DESCRIPTION OF DRAWINGS

The following describes a preferable embodiment of the present invention with reference to drawings, in order to illustrate the object and other objects of the present invention, features, and advantages more clearly.

FIG. 1

FIG. 1 is a schematic view illustrating a first method of a cell search process of an LTE-Advanced user apparatus.

FIG. 2

FIG. 2 is a flowchart illustrating the first method of the cell search process of the LTE-Advanced user apparatus.

FIG. 3

FIG. 3 is a schematic view illustrating a second method of the cell search process of the LTE-Advanced user apparatus.

FIG. 4

FIG. 4 is a flowchart illustrating the second method of the cell search process of the LTE-Advanced user apparatus.

FIG. 5

FIG. 5 is a schematic view illustrating the third method of the cell search process of the LTE-Advanced user apparatus.

FIG. 6

FIG. 6 is a flowchart illustrating the third method of the cell search process of the LTE-Advanced user apparatus.

FIG. 7

FIG. 7 is a view illustrating a topology of a relay enhanced cellular network in which a relay node transmits data to a user apparatus in a transparent mode.

FIG. 8

FIG. 8 is a schematic view illustrating a first method for a relay node to transmit data to a user apparatus in the transparent mode.

FIG. 9

FIG. 9 is a schematic view illustrating a second method for a relay node to transmit data to a user apparatus in the transparent mode.

FIG. 10

FIG. 10 is a schematic view illustrating subframe offset transmission of a base station and a relay node.

FIG. 11

FIG. 11 is a schematic view illustrating a third method for a relay node to transmit data to a user apparatus in the transparent mode.

FIG. 12

FIG. 12 is a schematic view illustrating a fourth method for a relay node to transmit data to a user apparatus in the transparent mode.

FIG. 13

FIG. 13 is a view illustrating a topology where transparent transmission and non-transparent transmission coexist in the relay enhanced cellular network.

FIG. 14

FIG. 14 illustrates a first method for allowing transparent transmission and non-transparent transmission of a relay node to coexist.

FIG. 15

FIG. 15 illustrates a second method for allowing transparent transmission and non-transparent transmission of a relay node to coexist.

### DESCRIPTION OF EMBODIMENTS

With reference to drawings, the following describes a preferable embodiment of the present invention in detail. For a more understandable explanation, the present embodiment omits unnecessary detailed descriptions of methods and system functions.

In order to describe how to realize the present invention in more detail, the following deals with a concrete embodiment to be applied to an LTE-Advanced cellular mobile communication system having a relay node. Needless to say, the present invention is applied not only to the following embodiment but also to other mobile communication systems having a relay node.

### <Cell Search Procedure of LTE-Advanced User Apparatus>

After an LTE user apparatus is started up, the LTE user apparatus needs to carry out a cell search process (cell search procedure). In the cell search process, the LTE user apparatus completes synchronous operation with a base station apparatus, and obtains a corresponding physical cell ID number. In the LTE-Advanced mobile communication system having a relay node, the relay node is transparent to the LTE user apparatus. That is, the LTE user apparatus covered by the relay node carries out operation transparently to the relay node, through an ordinary cell search process defined by a conventional LTE standard. Thus, the LTE user apparatus completes the synchronous operation and such obtainment of the physical cell ID number of the base station apparatus. Whether the relay node is transparent or non-transparent to the LTE-Advanced user apparatus in the LTE-Advanced mobile communication system having a relay node is determined depending on an arrangement of a system (system design, system planning). Therefore, the relay node can be both transparent and non-transparent to the LTE-Advanced user apparatus. In this case, the LTE-Advanced user apparatus covered by the relay node needs to first obtain type information (transparent or non-transparent) of the relay node in a cell search process. Then, the LTE-Advanced user apparatus uses a cell search process corresponding to the type information. In a case where the relay node is transparent, the LTE-Advanced user apparatus can carry out cell search in conventional LTE standard. In a case where the relay node is non-transparent, the LTE-Advanced user apparatus can carry out cell search in accordance with a cell search process according to the present invention (to be described later in detail). Integration of such two cell search processes to be used in the LTE-Advanced mobile communication system makes it possible to complete cell search processes for the base station, a transparent relay node, and a non-transparent relay node. Such an integrated cell search process can be realized as below.

### <First Cell Search Method of LTE-Advanced User Apparatus>

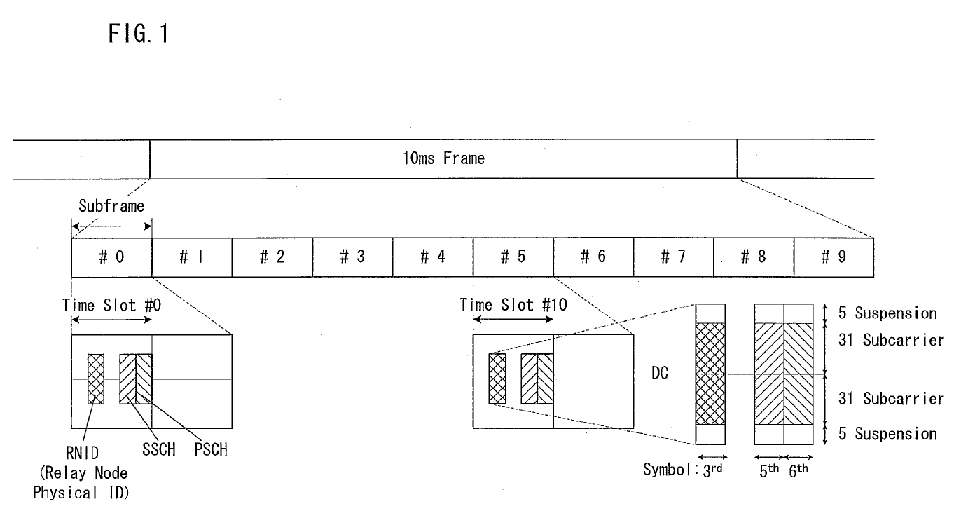

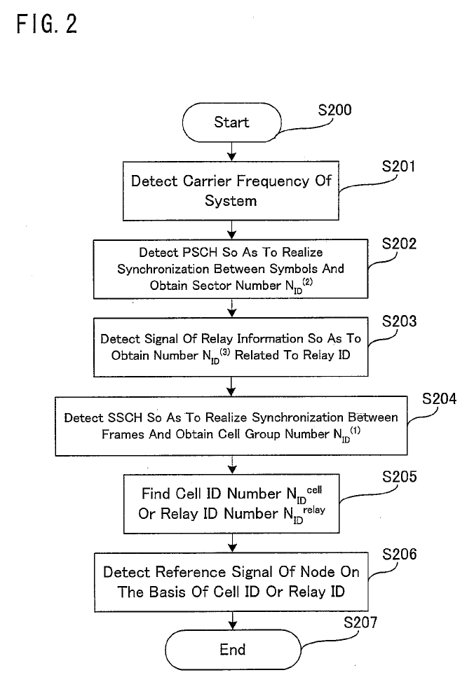

FIG. 1 is a view illustrating a first of a cell search process of the LTE-Advanced user apparatus. FIG. 2 is a flowchart for explaining the first method of the cell search process of the LTE-Advanced user apparatus.

As illustrated in FIG. 1, transmission of a primary synchronization signal (PSCH: Primary Synchronization Channel) and a sub-synchronization signal (SSCH: Secondary Synchronization Channel) on each of time slots (subframes) #0 and #10 which are defined by the LTE standard (i.e., in the transmission, SSCHs are on a fifth symbol of the time slot #0 and on that of the time slot #10, respectively, and PSCHs are on a sixth symbol of the time slot #0 and on that of the time slot #10, respectively) is held so that the primary synchronization signal and the sub-synchronization signal are used in synchronous operation which is carried out for realizing compatibility with the LTE-Advanced user apparatus. A sequence signal (RNID) related to a physical ID of a relay node is transmitted on a symbol of each of the time slots #0 and #10 which symbol is not involved in transmission of a reference signal (i.e., on a second or third symbol. For the present embodiment, on the third symbol). A special sequence Sₒ (The LTE standard defines 168 “m” sequences indicating 168 cell group numbers each of which 168 “m” sequences is a combination of parameters mₒ and m₁. Introduction of a new combination of the parameters mₒ and m₁ makes it possible to obtain a special sequence which is different from each of the 168 “m” sequences which are used in the LTE) indicates a relay type of transparent relay. In a case where the LTE-Advanced user apparatus detects the special sequence Sₒ, the LTE-Advanced user apparatus recognizes that a node from which the LTE-Advanced user apparatus receives data is a transparent relay node or a base station. In a case where the LTE-Advanced user apparatus detects a non-special special sequence, the LTE-Advanced user apparatus recognizes that the node from which the LTE-Advanced user apparatus receives the data is a non-transparent relay node. Simultaneously, the LTE-Advanced user apparatus obtains, from a sequence thus detected, an index number N_{ID}⁽³⁾ related to a physical ID of the relay node. FIG. 2 is a flowchart illustrating a processing flow of a cell search of the LTE-Advanced user apparatus. The following describes the flowchart in detail.

Step S201: The LTE-Advanced user apparatus detects a carrier frequency of a system.

Step S202: In a time domain, the LTE-Advanced user apparatus detects a primary synchronization signal PSCH so as to realize synchronization between symbols, and obtains, from a sequence of the primary synchronization signal PSCH, an index number N_{ID}⁽²⁾ (e.g., 0, 1, or 2) of a sector (one cell has three sectors).

Step S203: In the time domain, the LTE-Advanced user apparatus detects a sequence signal related to a physical ID of a relay node so as to determine, on the basis of a sequence thus detected, a type of the node from which the LTE-Advanced user apparatus receives data. That is, in a case where the sequence thus detected is a special sequence Sₒ, the LTE-Advanced user apparatus determines that the node from which the LTE-Advanced user apparatus receives data is a transparent relay node or a base station. In a case where the sequence thus detected is a non-special sequence, the LTE-Advanced user apparatus determines that the node from which the LTE-Advanced user apparatus receives data is a non-transparent relay node. In addition, the LTE-Advanced user apparatus obtains, from a sequence thus detected, an index number N_{ID}⁽³⁾ related to a physical ID of the non-transparent relay node.

Step S204: In a frequency domain, the LTE-Advanced user apparatus (i) detects a sub-synchronization signal SSCH so as to realize frame synchronization, and (ii) obtains, from a sequence thus detected from the sub-synchronization signal SSCH, a cell group number N_{ID}⁽¹⁾ (e.g., 0, 1, . . . , or 167).

Step S205: The LTE-Advanced user apparatus determines a physical ID of the cell or the relay node, in accordance with a type of the node from which the LTE-Advanced user apparatus receives data.

In a case where, e.g., the node from which the LTE-Advanced user apparatus receives data is a transparent relay node or a base station, the following expression (1) is satisfied.

N_{ID}^{cell}=3N_{ID}⁽¹⁾+N_{ID}⁽²⁾ (1)

In a case where the node from which the LTE-Advanced user apparatus receives data is a non-transparent relay node, a physical ID of the relay node satisfies the following expression (2) or (3).

N_{ID}^{relay}=504+K(3N_{ID}⁽¹⁾+N_{ID}⁽²⁾+N_{ID}⁽³⁾ (2)

N_{ID}^{relay}=504+N_{ID}⁽³⁾ (3)

In the expression (2), K represents the number of relay nodes that each of cells can maximally has.

These two calculation methods are merely concrete examples for explaining the present invention in more detail. Therefore, a technician of this technical field can employ another calculation method as necessary. Further, a physical ID of the relay node is found on the basis of the cell group number N_{ID}⁽¹⁾, the index number N_{ID}⁽²⁾ of the sector, and the index number N_{ID}⁽³⁾ which have been thus obtained.

Step S206: The LTE-Advanced user apparatus detects, from the physical ID of the cell or the physical ID of the relay node, a reference signal of the node that the LTE-Advanced user apparatus receives data.

Step S207: The cell search process is ended, and a system broadcast information obtaining process is started. As described above, the cell search process allows the LTE-Advanced user apparatus to (i) detect a type of a node from which the LTE-Advanced user apparatus receives data, (ii) realize synchronous operation, and (iii) obtain a cell ID number or a physical ID number of a relay node. A symbol of the sequence signal related to the transmission and to the physical ID of the relay node is any one of symbols, in a whole frame, except occupied synchronization symbols and occupied symbols of physical broadcast channels (PBCH), which one is not involved in transmission of the reference signal. In consideration of complexity of a filter, and an influence of other data transmission in actual system design, the inventors of the present invention proposed that the symbol be preferably located on a second or third symbol of each of subframes #0 and #5.

### <Second Cell Search Method of LTE-Advanced User Apparatus>

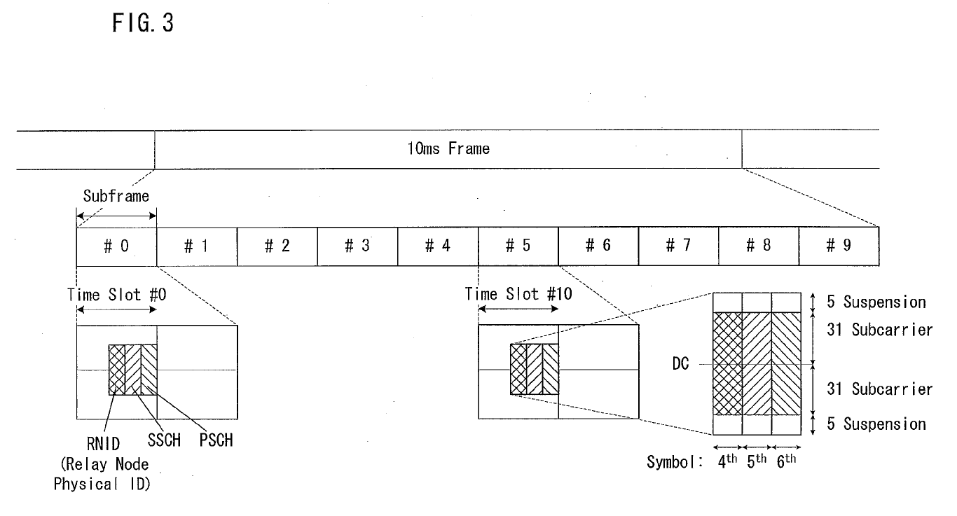

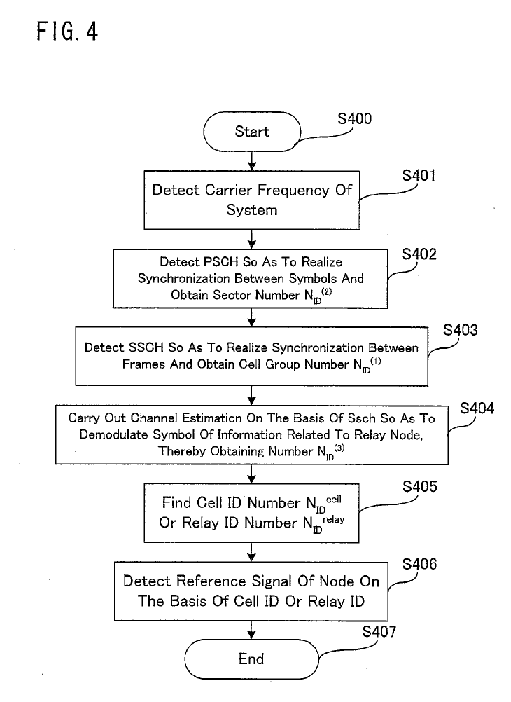

FIG. 3 is a view illustrating a second method of a cell search process of the LTE-Advanced user apparatus. FIG. 4 is a flowchart for explaining the second method of the cell search process of the LTE-Advanced user apparatus.

As illustrated in FIG. 3, transmission of a primary synchronization signal (PSCH) and a sub-synchronization signal (SSCH) on each of time slots (subframes) #0 and #10 which are defined by the LTE standard (i.e., in the transmission, SSCHs are on a fifth symbol of the time slot #0 and on that of the time slot #10, respectively, and PSCHs are on a sixth symbol of the time slot #0 and on that of the time slot #10, respectively) is held so that the primary synchronization signal and the sub-synchronization signal are used in synchronization operation which is carried out for realizing compatibility with the LTE-Advanced user apparatus. Information (RNID) related to a relay node is transmitted by use of a fourth symbol on each of time slots #0 and #10. The information is mapped only on 62 OFDM subcarriers distributed symmetrically with respect to a carrier center frequency (DC) of a node, as is the case with resource mapping of a synchronization signal. The information related to the relay node contains a type information of the relay node, information related to a physical ID number of the relay node, and other system-related information. The information related to the relay node can be modulated by a modulation method such as a QPSK method. The LTE-Advanced user apparatus realizes synchronization of the system in accordance with the synchronization process defined by the LTE, and then, carries out channel estimation by use of the synchronization signal. In accordance with a result of the channel estimation, the LTE-Advanced user apparatus carries out data demodulation of a forth symbol followed by a symbol containing the sub-synchronization signal, so as to obtain corresponding data information. The LTE-Advanced user apparatus thus obtains the information related to the relay node. FIG. 4 is a flowchart illustrating a processing flow of a cell search of the LTE-Advanced user apparatus. The following describes the flowchart in detail.

Step S401: The LTE-Advanced user apparatus detects a carrier frequency of the system.

Step S402: In a time domain, the LTE-Advanced user apparatus detects a primary synchronization signal PSCH so as to realize synchronization between symbols, and obtains, from a sequence of the primary synchronization signal PSCH, an index number N_{ID}^{(2) (e.g.,} 0, 1, or 2) of a sector (one cell has three sectors).

Step S403: In a frequency domain, the LTE-Advanced user apparatus (i) detects a sub-synchronization signal SSCH so as to realize frame synchronization, and (ii) obtains, from a sequence thus detected from the sub-synchronization signal SSCH, a cell group number N_{ID}⁽¹⁾ (e.g., 0, 1, . . . , or 167).

Step S404: The LTE-Advanced user apparatus carries out channel estimation by use of the sub-synchronization signal SSCH detected in S403. In accordance with a result of the channel estimation, the LTE-Advanced user apparatus carries out data demodulation of content of the fourth symbol followed by the fifth symbol containing the sub-synchronization signal so as to read a bit indicative of a type of the relay node. In a case where the relay node is a non-transparent relay node, the LTE-Advanced user apparatus (i) reads bit information related to a physical ID of the relay node, (ii) obtains an index number N_{ID}⁽³⁾, and (iii) obtains other related system information.

S405: The LTE-Advanced user apparatus determines a physical ID of a base station or the relay node, in accordance with a type of the node from which the LTE-Advanced user apparatus receives data.

In a case where, e.g., the node from which the LTE-Advanced user apparatus receives data is a transparent relay node or a base station, the following expression (1) is satisfied.

N_{ID}^{cell}=3N_{ID}⁽¹⁾+N_{ID}⁽²⁾ (1)

In a case where the node from which the LTE-Advanced user apparatus receives data is a non-transparent relay node, a physical ID of the relay node satisfies the following expression (2) or (3).

N_{ID}^{relay}=504+K(3N_{ID}⁽¹⁾+N_{ID}⁽²⁾)+N_{ID}⁽³⁾ (2)

N_{ID}^{relay}=504+N_{ID}⁽³⁾ (3)

In the expression (2), K represents the number of relay nodes that each of cells can maximally has.

These two calculation methods are merely concrete examples for explaining the present invention in more detail. Therefore, a technician of this technical field can employ another calculation method as necessary. Further, a physical ID of the relay node is found on the basis of the cell group number N_{ID}⁽¹⁾, the index number N_{ID}^{(2) of the sector, and the index number N}_{ID}⁽³⁾ which have been thus obtained.

Step S406: The LTE-Advanced user apparatus detects, from the physical ID of the cell or the physical ID of the relay node, a reference signal of the node that the LTE-Advanced user apparatus receives data.

Step S407: The cell search process is ended, and a system broadcast information obtaining process is started.

As described above, the cell search process allows the LTE-Advanced user apparatus to (i) detect a type of a node from which the LTE-Advanced user apparatus receives data, (ii) realize synchronous operation, and (iii) obtain a physical ID number of a base station or a physical ID number of a relay node. In a case where (i) a symbol followed by an SSCH symbol is modulated by a modulation method such as the QPSK method, (ii) the symbol transfers 82-bit data information except the OFDM subcarriers occupied by the reference signal, and (iii) necessary 16 CRC bits 66. In a case where one bit indicates a type of a relay node, and the relay node is a non-transparent relay node, K number of bits indicate the index number N_{ID}⁽³⁾, and remaining N (N=66−K−1) number of bits can be used for the related system information. In a case where the relay node is a transparent relay node or a base station, remaining N (N=66−1=65) number of bits can be used for the related system information. Therefore, the symbol can be taken as an extended part of the physical broadcast channel (PBCH) of the LTE-Advanced system. In contrast to a PBCH defined by the LTE, the LTE-Advanced user apparatus demodulates one of symbols in the extended part of the PBCH so as to obtain corresponding system information, by use of channel information (downlink wireless transmission channel status) obtained by the channel estimation using the sub-synchronization signal. Further, system information in other part of the PBCH which other part is defined by the LTE is demodulated by use of channel information obtained by use of an obtained reference signal.

### <Third Cell Search Method of LTE-Advanced User Apparatus>

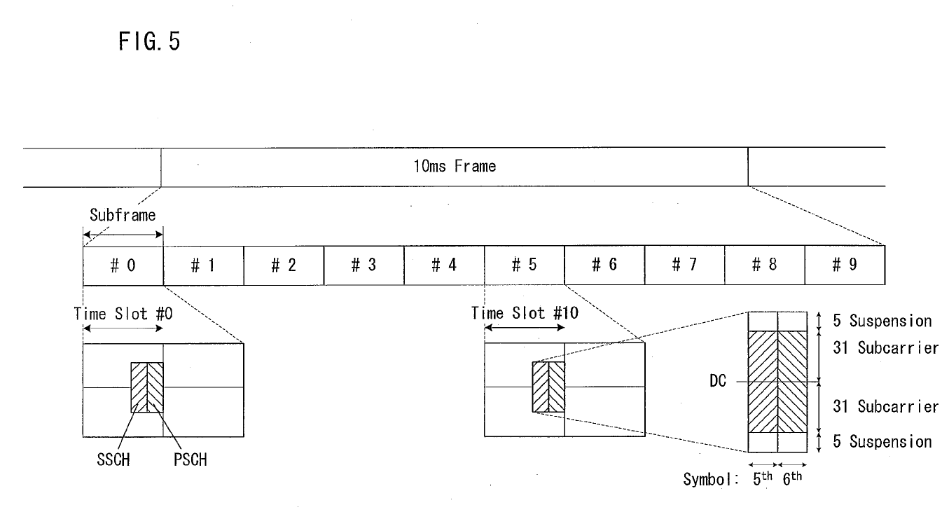

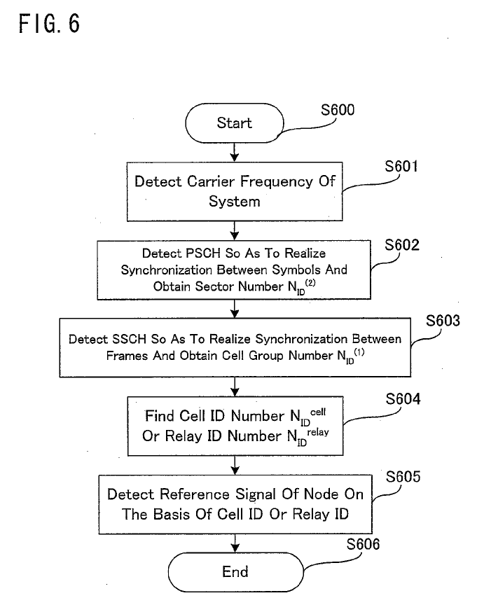

FIG. 5 is a view illustrating a third method of a cell search process of the LTE-Advanced user apparatus. FIG. 6 is a flowchart for explaining the second method of the cell search process of the LTE-Advanced user apparatus.

As illustrated in FIG. 5, transmission of a primary synchronization signal (PSCH) and a sub-synchronization signal (SSCH) on each of time slots (subframes) #0 and #10 which are defined by the LTE standard (i.e., in the transmission, SSCHs are on a fifth symbol of the time slot #0 and on that of the time slot #10, respectively, and PSCHs are on a sixth symbol of the time slot #0 and on that of the time slot #10, respectively) is held so that the primary synchronization signal and the sub-synchronization signal are used in synchronization operation which is carried out for realizing compatibility with the LTE-Advanced user apparatus. The LTE-Advanced user apparatus transmits a synchronization signal to each of a transparent relay node and a base station by a method defined by the LTE. On the other hand, the LTE-Advanced user apparatus transmits, on a PSCH symbol, a sequence other than three sequences which are defined by the LTE and are used in transmission of primary synchronization signals PSCH, to a non-transparent relay node, so as to tag the relay node as a non-transparent relay node and obtain an index number corresponding to the sequence (The three sequences correspond to three sector numbers, respectively. According to the LTE, a sequence to be used for a primary synchronization signal is a frequency domain ZC sequence. Respective root indexes of the three sequences are 25, 29, and 34). Similarly, the LTE-Advanced user apparatus transmits, on an SSCH, a sequence defined by the LTE or a newly-defined pair of sequences, to the non-transparent relay node, so as to obtain a corresponding index number. Further, the LTE-Advanced user apparatus finds a physical ID number of the non-transparent relay node on the basis of two index numbers thus obtained. FIG. 6 is a flowchart illustrating a processing flow of a cell search of the LTE-Advanced user apparatus. The following describes the flowchart in detail.

Step S601: The LTE-Advanced user apparatus detects a carrier frequency of the system.

Step S602: In a time domain, the LTE-Advanced user apparatus detects a primary synchronization signal PSCH so as to realize synchronization between symbols, and obtains, from a sequence of the primary synchronization signal PSCH, an index number N_{ID}⁽²⁾ of a sector. In a case where the sequence of the primary synchronization signal PSCH is one of the three sequences which are defined by the LTE and are used in transmission of the primary synchronization signal PSCH, the node from which the LTE-Advanced user apparatus receives data is a transparent relay node or a base station. In a case where the sequence of the primary synchronization signal PSCH is none of the three sequences which are defined by the LTE and are used in transmission of the primary synchronization signal PSCH, the node from which the LTE-Advanced user apparatus receives data is a non-transparent relay node.

Step S603: In a frequency domain, the LTE-Advanced user apparatus (i) detects a sub-synchronization signal SSCH so as to realize frame synchronization, and (ii) obtains, from a sequence thus detected from the sub-synchronization signal SSCH, a cell group number N_{ID}⁽¹⁾. Whether or not the sequence thus detected is one defined by the LTE does not make any difference. However, the sequence thus detected is required to always correspond to one cell group number.

Step S604: The LTE-Advanced user apparatus determines a physical ID of a base station or the relay node, in accordance with a type of the node from which the LTE-Advanced user apparatus receives data.

In a case where, e.g., the node from which the LTE-Advanced user apparatus receives data is a transparent relay node or a base station, the following expression (1) is satisfied.

N_{ID}^{cell}=3N_{ID}⁽¹⁾+N_{ID}⁽²⁾ (1)

In a case where the node from which the LTE-Advanced user apparatus receives data is a non-transparent relay node, it is possible to find a physical ID of the non-transparent relay node on the basis of N_{ID}⁽²⁾ and N_{ID}⁽²⁾.

These two calculation methods are merely concrete examples for explaining the present invention in more detail. Therefore, a technician of this technical field can employ another calculation method as necessary. Further, a physical ID of the relay node is found on the basis of the cell group number N_{ID}⁽¹⁾, the index number N_{ID}⁽²⁾ of the sector, and the index number N_{ID}⁽³⁾ which have been thus obtained.

Step S605: The LTE-Advanced user apparatus detects, from the physical ID of the cell or the physical ID of the relay node, a reference signal of the node that the LTE-Advanced user apparatus receives data.

S606: The cell search process is ended, and a system broadcast information obtaining process is started.

As described above, the cell search process allows the LTE-Advanced user apparatus to (i) detect a type of a node from which the LTE-Advanced user apparatus receives data, (ii) realize synchronous operation, and (iii) obtain a physical ID number of a base station or a physical ID number of a relay node.

### <Design of Relay Node Transparent Transmission Data>

According to a definition of a transparent relay node in a 3GPP technical report TR36.814 (http://www.3gpp.org/ftp/Specs/html-info/36814.htm), a user apparatus cannot recognize a transparent relay node, and employment of an operation flow defined by the LTE as that of an LTE user apparatus allows the LTE user apparatus to appropriately access an LTE-Advanced system having a relay node. With regard to concrete design of a transparent relay having upward compatibility in an LTE-Advanced system, the present embodiment deals with the following practical methods.

As for a feature of a relay system, subframes of the relay system are classified into relay subframes and non-relay subframes. A base station transmits to a relay node, data information corresponding to the relay node so that the relay node receives the data information. In order to prevent a possible problem of interference, the relay node cannot transmit data information corresponding to a user at the relay node, simultaneously with receiving the data information from the base station. Currently, 3GPP is under study as to whether or not a relay node is required to transmit downlink control channel (PDCCH: Physical Downlink Control Channel) information and a common reference signal (CRS), and whether or not the relay node is required to give instructions to the relay subframes by use of a special signal. However, such issues do not affect practical use of methods of the present embodiment. The present invention mainly solves a problem in resource allocation and a problem in data transmission.

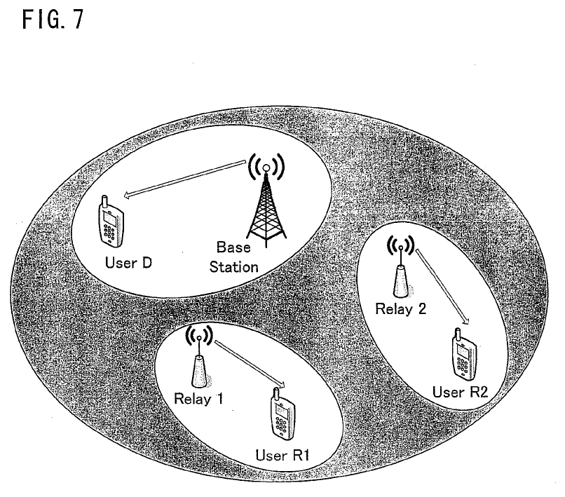

Before the methods of the present embodiment are described, the following first describes typical scenes in which the present invention is applicable. FIG. 7 is a view illustrating a topology of a cellular network having relay nodes which transparently transmit data to user apparatuses. A base station apparatus (“BASE STATION” in FIG. 7) serves as a center of scheduling and control of services in a whole cell. Each of the relay nodes (“RELAY 1” and “RELAY 2” in FIG. 7) receives data from the base station apparatus, and decodes the data so as to transmit the data thus decoded to a corresponding one of the the user apparatuses (“USER D,” “USER R1,” and “USER R2” in FIG. 7) receives data from the base station and/or a corresponding one of the relay nodes, and transmits data to the base station and/or a corresponding one of the relay nodes. The user apparatuses are classified into a directly-connected user apparatus (“USER D” in FIG. 7) and relay user apparatuses (“USER R1” and “USER R2” in FIG. 7), depending a related signal transmission route. The directly connected user apparatus is a user apparatus which has directly established a connection service with the base station. In general, the directly-connected user apparatus realizes a good wireless link quality between the directly-connected user apparatus and the base station. The relay user apparatuses are user apparatuses each of which provides a connection service via a relay node. In general, each of the relay user apparatuses realizes a good wireless link quality between the relay user apparatus and a relay node. In FIG. 7, a cell controlled by the base station has two relay nodes relay 1 and relay 2. The user D is a user apparatus directly connected with the base station. The user R1 is a user apparatus connected with the relay 1. The user R2 is a user apparatus connected with the relay 2.

<First Method of Transparent Data Transmission from Relay Node to User Apparatus>

The base station apparatus carries out scheduling of all user apparatuses (including directly-connected user apparatuses and relay user apparatuses) connected with the base station apparatus in an integrated manner. In a relay subframe, the base station apparatus transmits, to all relay nodes connected with the base station apparatus, all of service information and control information which are subjected to the scheduling, by a broadcast or multicast. Simultaneously, in a non-relay subframe, the base station apparatus transmits, to all the relay nodes connected with the base station apparatus, corresponding control information and service information via all the relay nodes.

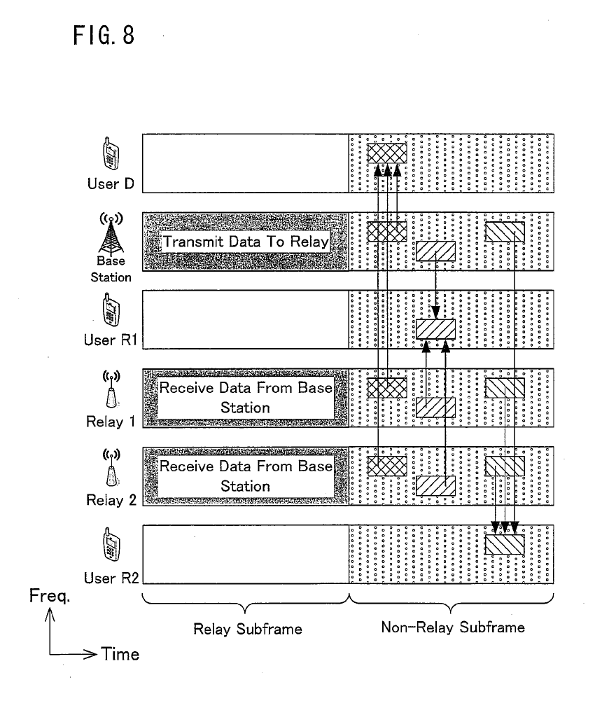

FIG. 8 illustrates a first method in which the relay nodes transparently transmit data to the user apparatuses.

As illustrated in FIG. 8, in a relay subframe, the base station transmits data to each of the relay 1 and relay 2. On the other hand, in non-relay subframes, the base station and the relays 1 and 2 simultaneously transmit identical data to one user apparatus by use of resources which are identical in time and frequency. In a current subframe, time-frequency resource blocks which are scheduled to be transmitted to different user apparatuses are perpendicular to each other. As illustrated in FIG. 8, a horizontal axis represents time and a vertical axis represents frequencies, with respect to rectangles representing subframes. The resources which are identical in time and frequency refer to resource blocks which are located in same positions in different subframes (e.g., resource blocks indicated by lines sloping down to the right which resource blocks are transmitted to the user apparatus R2). “Resource blocks . . . are perpendicular to each other” refers to resource blocks which are different in time and frequency and which are transmitted to the user apparatuses D, R1, and R2, respectively (e.g., a resource block indicated by cross-hatching, a resource block indicated by lines sloping down to the left, and a resource block indicated by lines sloping down to the right are perpendicular to each other). Each of the user apparatuses (including the user D, the user R1, and the user R2) in the cell receives, via non-relay subframes, a composite common reference signal from each of the base station and the relays 1 and 2, and also data information into which pieces of data information from the base station and the relays 1 and 2 have been combined. On the basis of the composite common reference signal, each of the user apparatuses finds combined data information, and feeds back combined channel information and combined measurement data to the base station and/or the relays 1 and 2.

<Second Method of Transparent Data Transmission from Relay Node to User Apparatus>

A conventional art document (R1-084412, LTE signaling to support Relay operation, Motorola, 3GPP RANI #55, Nov. 10-14, 2008) has the following related description. That is, a method utilizing displacement of a subframe number between a relay node to transmit respective different reference signals at a time. This allows the base station and the relay node to use, in a multiplexed manner, resource blocks which are identical in time and frequency so as to transmit respective different pieces of data information.

FIG. 10 is a view illustrating subframe offset transmission of a base station and a relay node.

As illustrated in FIG. 10, a second subframe of the base station and a zeroth subframe of the relay node correspond to each other. Thus, there is displacement corresponding to two subframes between a subframe number of the relay node and a subframe number of the base station apparatus in the cell. In this case, the base station obtains a sequence of a corresponding reference signal RS1 (RS: Reference Signal), on the basis of a cell physical ID of the base station and a slot number of a slot in the current subframe #2 (one subframe contains two slots). On the other hand, each of the relay nodes in the cell obtains a sequence of a reference signal RS0 which is different from the reference signal RS1 obtained by the base station, on the basis of a physical ID of the relay node (the physical ID matches the cell physical ID of the base station) and a slot number of a slot in the current subframe #0. Since respective sequences of the reference signals RS0 and RS1 are different, the base station and each of the relay nodes can use, in a multiplexed manner, resource blocks which are identical in time and frequency so as to transmit respective different pieces of data information. However, all the relay nodes in the cell transmit identical reference signals. Therefore, the relay nodes cannot use resource blocks which are identical in time and frequency so as to transmit respective different pieces of data information.

The method utilizing displacement between subframes makes it possible to further improve the first method of transparent data transmission from a relay node to a user apparatus. Accordingly, the base station apparatus carries out, in an integrated manner, scheduling of all the user apparatuses which are connected with the relay nodes. In a relay subframe, the base station apparatus transmits, to all the relay nodes connected with the base station apparatus, all of service information and control information which are subjected to the scheduling, by a broadcast and/or multicast. Further, the base station apparatus uses a non-relay subframe so as to carry out scheduling of a directly-connected user apparatus(es), and transmits corresponding control information and service information to the directly-connected user apparatus(es). All the relay nodes transmit, to a relay user apparatus(es), the control information and service information which have been received via the relay subframes.

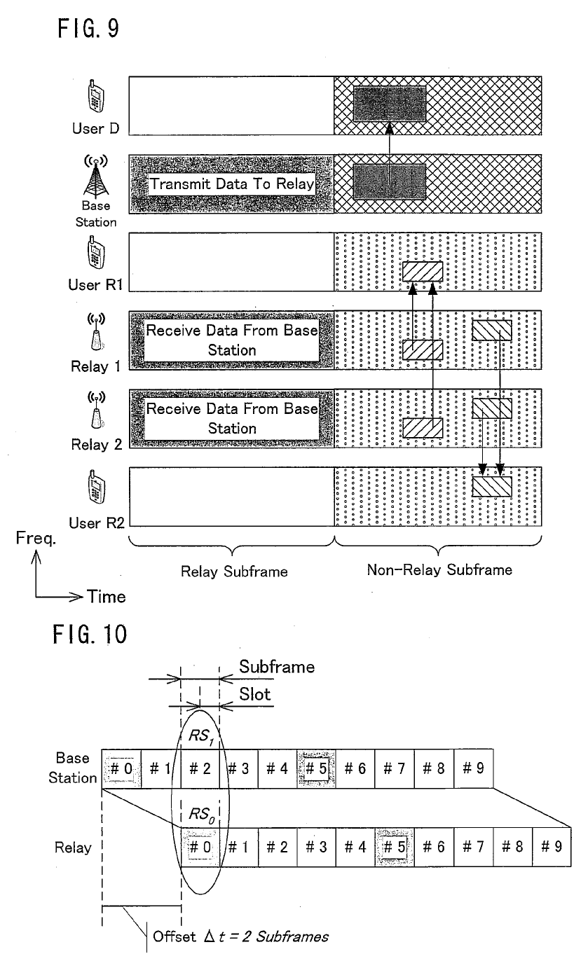

FIG. 9 illustrates a second method of transparent data transmission from a relay node to a user apparatus.

As illustrated in FIG. 9, in a relay subframe, the base station transmits control information and data information which have been scheduled by a relay user apparatus to the relay nodes 1 and 2. In a non-relay subframe, the base station schedules and transmits corresponding control information and corresponding data information to a directly-connected user apparatus(es). In FIG. 9, the corresponding control information and the corresponding data information are indicated by a black block in a non-relay subframe of the base station which black block is transferred from the base station to the user D. Each of the relays 1 and 2 receives scheduling information from the base station so as to transmit, on the basis of the scheduling information, identical data to a certain relay user apparatus at a time by use of resource blocks which are identical in time and frequency. For example, in FIG. 9, the identical data is indicated by blocks indicated by lines sloping down to the right in non-relay subframes of the relays 1 and 2 which blocks are transferred from the relays 1 and 2 to the user R1. Time-frequency resource blocks which are scheduled in current non-relay subframes by all the relay nodes in the cell to be transmitted to different user apparatuses are perpendicular to each other. For example, in FIG. 9, such time-frequency resource blocks are blocks indicted by lines sloping down to the left and blocks indicted by lines sloping down to the right. The directly-connected user D in the cell directly receives a common reference signal and data information from the base station via a non-relay subframe. Each of the users R1 and R2 receives, via a non-relay subframe, a composite common reference signal into which a reference signal from the relay 1 and a reference signal from relay 2 have been combined, and also data information into which data information from the relay 1 and data information from the relay 2 have been combined. On the basis of the composite common reference signal, each of the users R1 and R2 finds combined data information, and feeds back combined channel information and combined measurement data to the base station and/or the relays 1 and 2.

<Third Method of Transparent Data Transmission from Relay Node to User Apparatus>

In the third method, the method utilizing displacement between subframes, which was used in the second method, is used, and the base station and a relay node use all time-frequency resources in a multiplexed manner. The base station apparatus carries out, in an integrated manner, scheduling of all the user apparatuses which are connected with the relay nodes. In a relay subframe, the base station apparatus transmits, to all the relay nodes connected with the base station apparatus, all of service information and control information which are subjected to the scheduling, by unicast, or a broadcast and/or multicast.

The base station carries out scheduling of relay user apparatuses which are connected with different relay nodes so partial frequency bandwidth in different system frequency bandwidths (e.g., 20 MHz). In addition, the relay user apparatuses operate in a transmission mode 7 (3GPP TS 36.213, UE DL transmission mode) which is defined by the specifications of the LTE, and carry out data demodulation by use of a reference signal on an antenna port 5.

By use of a non-relay subframe, the base station apparatus carries out scheduling of the directly-connected user apparatus D so as to transmit corresponding control information and corresponding service information to the directly-connected user apparatus D. All the relay nodes transmit control information for the relay user apparatuses in the cell within a system frequency bandwidth. The relay nodes transmit common control information and data information to the user apparatuses R1 and R2 in the subband set assigned by the base station. The relay nodes do not transmit any data nor signal in a frequency bandwidth except the subband set assigned by the base station.

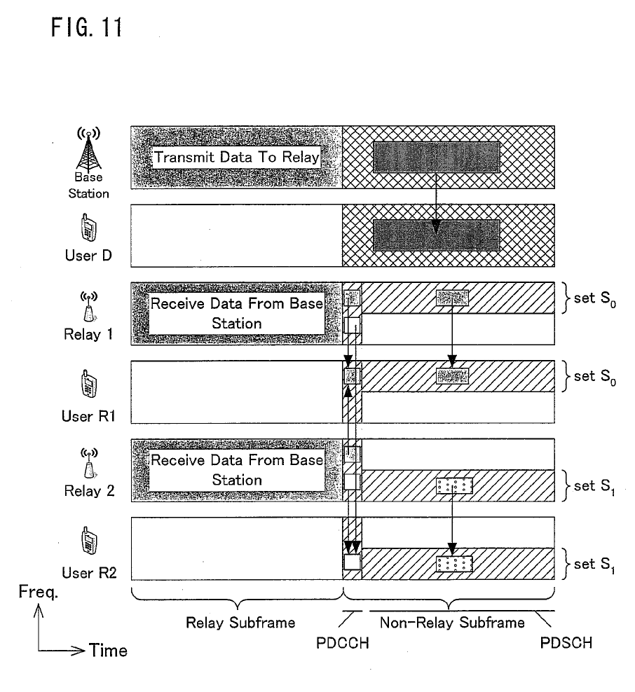

FIG. 11 illustrates a third method of transparent data transmission from a relay node to a user apparatus. As illustrated in FIG. 11, the base station (i) configures the users R1 and R2 so that the users R1 and R2 operate in the transmission mode 7, (ii) configures the user R1 which connects to the relay 1 so that the user R1 carries out feedback in a sub-band set “set Sₒ,” and (iii) configures the user R2 which connects to the relay 2 so that the user R2 carries out feedback in a sub-band band set “set S₁,” in accordance with a upper layer signal.

In a relay subframe, the base station transmits control information and data information which have been scheduled by relay user apparatuses (including the users R1 and R2) to the relays 1 and 2. By use of a non-relay subframe, the base station schedules corresponding control information and corresponding data information so as to transmit the corresponding control information and corresponding data information to the directly-connected user D. In FIG. 11, the corresponding control information and the corresponding data information are indicated by a black block in a non-relay subframe of the base station which black block is transferred from the base station to the user D. Each of the relays 1 and 2 receives scheduling information from the base station so as to transmit at a time, on the basis of the scheduling information, identical PDCCH information to a certain relay user apparatus by use of resource blocks which are identical in time and frequency in downlink control information regions of the relays 1 and 2. The relay 1 transmits data information to the user R1 by use of a time-frequency resource block in the subband set “set Sₒ.” However, the relay 1 does not transmit any information (nor a common reference signal) by use of a time-frequency resource block outside the subband set “set Sₒ.” In FIG. 11, the data information is indicated by a gray block in a non-relay subframe of the relay 1 except a PDCCH region which, gray block is transferred from the relay 1 to the user R1. The relay 2 transmits data information to the user R2 by use of a time-frequency resource block in the subband set “set S₁.” However, the relay 2 does not transmit any information (nor a common reference signal) by use of a time-frequency resource block outside the subband set “set S₁.” In FIG. 11, the data information is indicated by a dotted block in a non-relay subframe of the relay 2 except a PDCCH region which dotted block is transferred from the relay 2 to the user R2.

Each of the user R1 which connects to the relay 1 and the user R2 which connects to the relay 2 receives, in respective PDCCH regions, a composite common reference signal into which a reference signal from the relay 1 and a reference signal from the relay 2 are combined so as to decode corresponding control information. Further, the user R1 receives, in a PDSCH (Physical Downlink Shared Channel) region, only a common reference signal CRS from the relay 1, a user data demodulation reference signal (DMRS: Demodulation Reference Signal) applied to the antenna port 5, and corresponding data information so as to carry out feedback on channel information on the basis of the common reference signal CRS received from the relay 1 and demodulate the corresponding data information by use of the user data demodulation reference signal. Similarly, the user R2 receives, in a PDSCH (Physical Downlink Shared Channel) region, only a common reference signal CRS from the relay 2, a user data demodulation reference signal applied to the antenna port 5, and corresponding data information so as to carry out feedback on channel quality on the basis of the common reference signal CRS received from the relay 2 and demodulate the corresponding data information by use of the user data demodulation reference signal.

<Fourth Method for Transparent Data Transmission from Relay Node to User Apparatus>

The present embodiment further provides the following method, in consideration of a possibility of data transmission (Carrier Aggregation) that the LTE-Advanced system carries out by use of a plurality of carrier frequencies.

In the fourth method, the method utilizing displacement between subframes, which was used in the second method, is used, and the base station and a relay node use any time-frequency resource blocks in a multiplexed manner.

The base station apparatus carries out scheduling of all the user apparatuses which are connected with the relay nodes. The base station apparatus uses a relay subframe at one carrier frequency bandwidth or at a plurality of carrier frequency bandwidths so as to transmit, to all the relay nodes connected with the base station apparatus, all of scheduled service information and scheduled control information which are to be transmitted to relay user apparatuses, by unicast, or a broadcast and/or multicast. The relay nodes use respective different carrier frequency bandwidths so as to transmit data to user apparatuses. The relay nodes do not transmit any signal in a carrier frequency bandwidth in which no data is transmitted.

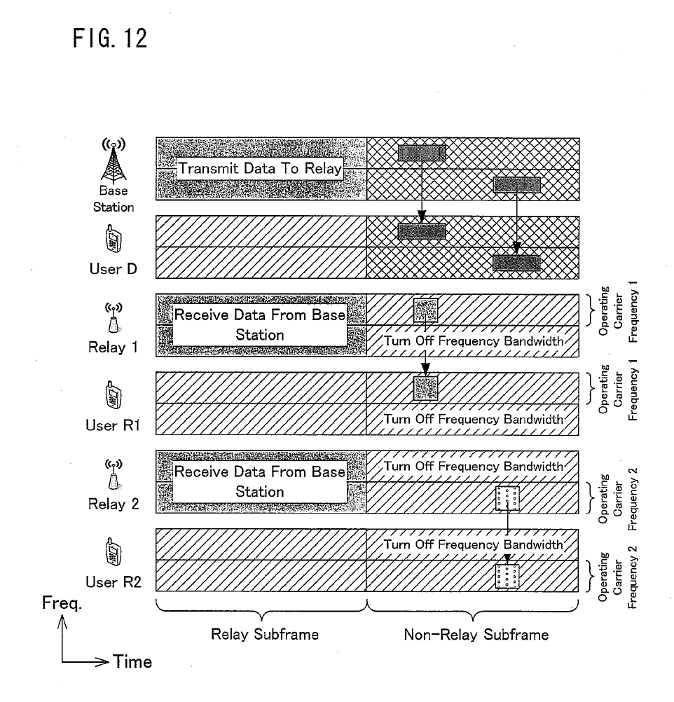

FIG. 12 illustrates a fourth method for transparent data transmission from a relay node to a user apparatus.

As illustrated in FIG. 12, the base station configures the users R1 and R2 in accordance with an upper layer signal so that the user R1 operates at an operating carrier frequency 1 and the user 2 operates at an operating carrier frequency 2.

In a relay subframe, the base station transmits control information and data information which have been scheduled by relay user apparatuses (including the users R1 and R2) to the relays 1 and 2. By use of a non-relay subframe, the base station schedules corresponding control information and corresponding data information so as to transmit the corresponding control information and corresponding data information to the directly-connected user D. In FIG. 12, the corresponding control information and the corresponding data information are indicated by a black block in a non-relay subframe of the base station which black block is transferred from the base station to the user D. The relay 1 receives scheduling information from the base station so as to transmit, on the basis of the scheduling information, data to the user R1 at the operating carrier frequency 1. In FIG. 12, the data is indicated by a gray block in a non-relay subframe of the relay 1 which gray block is transferred from the relay 1 to the user R1. The relay 2 receives scheduling information from the base station so as to transmit, on the basis of the scheduling information, data to the user R2 at the operating carrier frequency 2. In FIG. 12, the data is indicated by a dotted block in a non-relay subframe of the relay 2 which dotted block is transferred from the relay 2 to the user R2.

The user R1 which connects to the relay 1 (i) reads system information at the operating carrier frequency 1, (ii) uses a frequency bandwidth of the operating carrier frequencies 1 as the system frequency bandwidth so as to read corresponding control information and corresponding data information in the frequency bandwidth of the operating carrier frequency 1, and (iii) carries out feedback on a corresponding measurement result. Similarly, the user R2 which connects to the relay 2 (i) reads system information at the operating carrier frequency 2, (ii) uses a frequency bandwidth of the operating carrier frequency 2 as the system frequency bandwidth so as to read corresponding control information and corresponding data information in the frequency bandwidth of the operating carrier frequency 2, and (iii) carries out feedback on a corresponding measurement result.

In the third and fourth methods of transparent data transmission from a relay node to a user apparatus, the method utilizing displacement between subframes which method is illustrated in FIG. 10 is employed. However, the present invention is not limited to this but a conventional method (i.e., a method in which it is not required to shift a subframe number of a base station and that of a relay node from each other) can be employed.

In a case where e.g., the method utilizing displacement between subframes is not employed in the third method, the base station and the relay nodes can use all subband sets in a multiplexed manner by the following method. That is, the base station sets a single subband set (Sₒ) for relay user apparatuses R1 to be connected with one relay node 1 and sets a single subband set (Sᵢ) for relay user apparatuses R2 to be connected with one relay node 2, in accordance with an upper layer signal. The base station sets a single subband set (S_{B}) for directly-connected user apparatuses D to be connected with the base station, in accordance with the upper layer signal. The subband sets Sₒ, S₁, and S_{B} are perpendicular to each other. In PDCCH regions which correspond to control information of the non-relay subframes, the base station and all the relay nodes transmit identical control information to one user apparatus by use of resource blocks which are identical in time and frequency, and transmit common reference signals to the one user apparatus across the system frequency bandwidth. In PDSCH regions corresponding to data information of the non-relay subframes, each of the base station and the relay nodes transmits a common reference signal, a specialized reference signal (e.g., a demodulation reference signal DMRS applied to the antenna port 5), and corresponding data information to a corresponding user apparatus, in a subband set (Sₒ, S₁, or S_{B}) of the corresponding user apparatus. On the other hand, the base station and the relay nodes do not transmit any data nor signal (nor a common reference signal) by use of resource other than the subband sets thus assigned.

Further, in a case where the method utilizing displacement between subframes is not employed in the fourth method, the base station and the relay nodes can use all subband sets in a multiplexed manner by the following method. That is, the base station sets a single carrier frequency (operating carrier frequency 1) for relay user apparatuses R1 to be connected with one relay node 1 and sets a single carrier frequency (operating carrier frequency 2) for relay user apparatuses R2 to be connected with one relay node 2, in accordance with an upper layer signal. The base station sets a single carrier frequency (carrier frequency B) for directly-connected user apparatuses D to be connected with the base station, in accordance with an upper layer signal. In a non-relay subframe, the base station transmits, at the carrier frequency (carrier frequency B) assigned to the directly-connected user apparatuses D, data information to the directly-connected user apparatuses D. In a non-relay subframe, the relay node 1 transmits, at the operating carrier frequency 1, data information to the relay user apparatuses R1. In a non-relay subframe, the relay node 2 transmits, at the operating carrier frequency 2, data information to the relay user apparatuses R2. Each of the base station and the relay nodes 1 and 2 does not use carrier frequencies other than the carrier frequencies (carrier frequency B and operating carrier frequencies 1 and 2) assigned to the directly-connected user apparatuses D to be connected with the base station, the relay user apparatuses R1 to be connected with the relay node 1, and the relay user apparatuses R2 to be connected with the relay node 2.

With regard to the third and fourth methods, the above has shown a case where a system contains a few relay nodes such as the two relay nodes (relay nodes 1 and 2). However, the method utilizing displacement between subframes, which is illustrated in FIG. 10, makes it possible to apply the present invention to a case where a system contains many relay nodes. In this case, relay nodes which are away in spatial distance can use resource blocks which are identical in time and frequency, in a multiplexed manner. This makes it possible to prevent a shortage of time-frequency resource, and further improve utilization of system resource. In order to describe this, the following shows one example.

That is, a serving cell of a base station contains six relay nodes (relay nodes a to f). The relay node a is adjacent to the relay node b. The relay node b is adjacent to the relay nodes a and c. The relay node c is adjacent to the relay nodes b and d.

The relay node d is adjacent to the relay nodes c and e. The relay node f is adjacent to the relay node e. The relay nodes a, c, and e can be taken as a relay node 1, and the relay nodes b, d, and f can be taken as a relay node 2. With reference to FIG. 11, the subband set “set Sₒ” can be used for the relay nodes a, c, and e, and the subband set “set S₁” can be used for the relay nodes b, d, and f. Further, with reference to FIG. 12, the operating carrier frequency 1 can be used for the relay nodes a, c, and e, and the operating carrier frequency 2 can be used for the relay nodes b, d, and f. The above has exemplified a case where resource blocks which are identical in time and frequency are used in a multiplexed manner across one relay node. However, the present invention is also applicable to a case where resource blocks which are identical in time and frequency are used in a multiplexed manner across two ore more relay nodes.

### <Design for Coexistence of Transparent Transmission and Non-transparent Transmission of Relay Node>

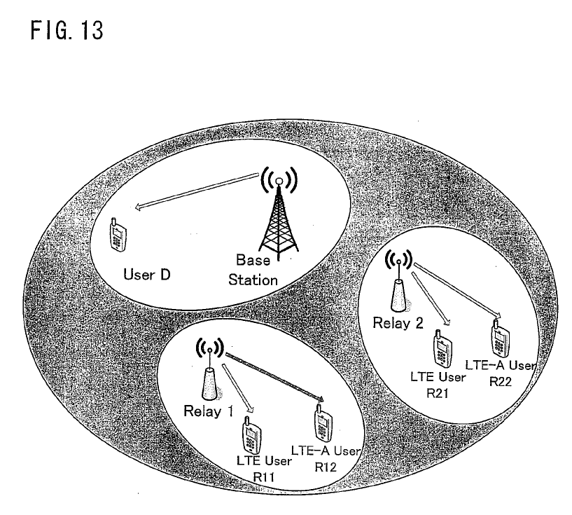

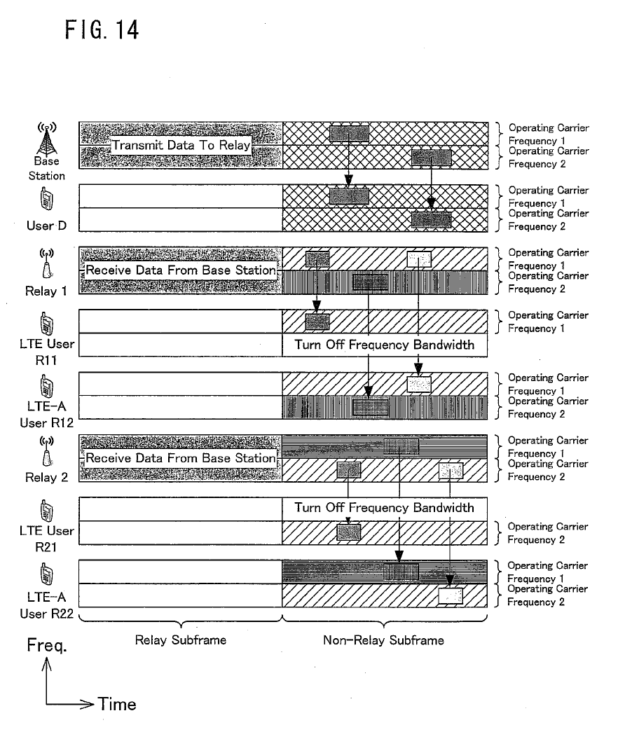

FIG. 13 is a topological view illustrating coexistence of the transparent transmission and the non-transparent transmission in a cellular network having relay nodes.

The present embodiment describes a case of FIG. 13 in detail as an example. In FIG. 3, a directly-connected user apparatus D is directly connected with a base station apparatus. The directly-connected user apparatus D can be an LTE-user apparatus or an LTE-Advanced user apparatus. An LTE relay user apparatus R11 and an LTE-Advanced relay user apparatus R12 are user apparatuses which connect to a relay node 1. An LTE relay user apparatus R21 and an LTE-Advanced relay user apparatus R22 are user apparatuses which are connected to a relay node 2.

### <First Method for Allowing Transparent Transmission and Non-transparent Transmission of Relay Node to Coexist>

In an LTE-Advanced system, data transmission is carried out by use of a plurality of carrier frequency bandwidths (Carrier Aggregation). The LTE-Advanced system uses the method utilizing displacement between subframes which method was used in the second method. In the LTE-Advanced system, the base station and the relay nodes can use any time-frequency resource blocks in a multiplexed manner.

The base station apparatus carries out scheduling of carrier frequency bandwidths at which the relay nodes in the cell operate in a transparent mode, in order to secure the carrier frequency bandwidths so that the carrier frequency bandwidths are perpendicular to each other. Further, the relay nodes operate in a non-transparent mode at the other carrier frequency bandwidths.

The base station apparatus carries out scheduling of all the user apparatuses which are connected with the relay nodes. The base station apparatus uses a relay subframe at one carrier frequency bandwidth or at a plurality of carrier frequency bandwidths so as to transmit, to all the relay nodes connected with the base station apparatus, all of scheduled service information and scheduled control information which are to be transmitted to relay user apparatuses, by unicast, or a broadcast and/or multicast.

Each of the relay nodes transmits data to the LTE relay user apparatuses or to the LTE-Advanced relay user apparatuses at a carrier frequency bandwidth which allows operation in the transparent mode. Each of the relay nodes transmits data to the LTE-Advanced relay user apparatuses at a carrier frequency bandwidth at which the relay nodes operate in the non-transparent mode.

FIG. 14 illustrates a first method for allowing transparent transmission and non-transparent transmission of a relay node to coexist.

As illustrated in FIG. 14, the base station configures, in accordance with an upper layer signal, an operating carrier frequency 1 of the relay node 1 so that the relay node 1 operates in the transparent mode and transparently transmits data to the LTE relay user apparatuses and to the LTE-Advanced relay user apparatuses. Similarly, the base station configures, in accordance with an upper layer signal, an operating carrier frequency 2 of the relay node 2 so that the relay node 2 operates in the transparent mode and transparently transmits data to the LTE relay user apparatuses and to the LTE-Advanced relay user apparatuses. Further, the base station configures, in accordance with an upper layer signal, an operating carrier frequency 1 of the relay node 2 so that the relay node 2 operates in the non-transparent mode and non-transparently transmits data to the LTE-Advanced relay user apparatuses.

In a relay subframe, the base station transmits, to the relay nodes 1 and 2, control information and data information which have been scheduled by relay user apparatuses (including the LTE relay user apparatuses and the LTE-Advanced relay user apparatuses). The base station uses a relay subframe so as to schedule and transmit corresponding control information and corresponding data information to the directly-connected user apparatus D.

In accordance with scheduling information and corresponding arrangement information which have been received from the base station, the relay node 1 transmits, at the operating carrier frequency 1, data information to the LTE relay user apparatus R11 and the LTE-Advanced relay user apparatus R12, and transmits, at the operating carrier frequency 2, data information to the LTE-Advanced relay user apparatus R12. The LTE relay user apparatus R11 operates only at the operating carrier frequency 1 so as to read corresponding control information and corresponding data information on the basis of system information and a reference signal which have been received at the operating carrier frequency 1, and carry out feedback on a corresponding measurement result. The LTE relay user apparatus R12 operates at the operating carrier frequencies 1 and 2 so as to (i) read data information transmitted at each of the operating carrier frequencies 1 and 2 on the basis of a reference signal and a control signal which have been received at the operating carrier frequency 1 and those received at the operating carrier frequency 2, and (ii) carry out feedback on a measurement result at each of the operating carrier frequencies 1 and 2.

In accordance with scheduling information and corresponding configuration information which have been received from the base station, the relay node 2 transmits, at the operating carrier frequency 2, data information to the LTE relay user apparatus R21 and the LTE-Advanced relay user apparatus R22, and transmits, at the operating carrier frequency 1 data information to the LTE-Advanced relay user apparatus R22. The LTE relay user apparatus R21 operates only at the operating carrier frequency 2 so as to read corresponding control information and corresponding data information on the basis of system information and a reference signal which have been received at the operating carrier frequency 2, and carry out feedback on a corresponding measurement result. The LTE relay user apparatus R22 operates at the operating carrier frequencies 1 and 2 so as to (i) read data information transmitted at each of the operating carrier frequencies 1 and 2 on the basis of a reference signal and a control signal which have been received at the operating carrier frequency 1 and those received at the operating carrier frequency 2, and (ii) carry out feedback on a measurement result at each of the operating carrier frequencies.

According to the first method for allowing transparent transmission and non-transparent transmission of a relay node to coexist, an LTE-Advanced relay user apparatus can carry out a cell search process by use of a cell search process according to any one of cell search methods 1 to 3 illustrated in FIGS. 1 to 6. Note that the fourth method for transparent data transmission from a relay node to a user apparatus is applicable to the first method for allowing transparent transmission and non-transparent transmission of a relay node to coexist.

### <Second Method for Allowing Transparent Transmission and Non-transparent Transmission of Relay Node to Coexist>

The coexistence of transparent relay and non-transparent relay can also be realized by a time-division method. A mechanism of this is as below. That is, a non-relay subframe is divided into a transparent subframe and a non-transparent subframe. A relay node operates in a transparent mode so as to transparently transmit, by use of the transparent subframe, data to an LTE relay user apparatus or an LTE-Advanced relay user apparatus. On the other hand, the relay node operates in a non-transparent mode so as to non-transparently transmit, by use of the non-transparent subframe, data to an LTE-Advanced relay user apparatus.

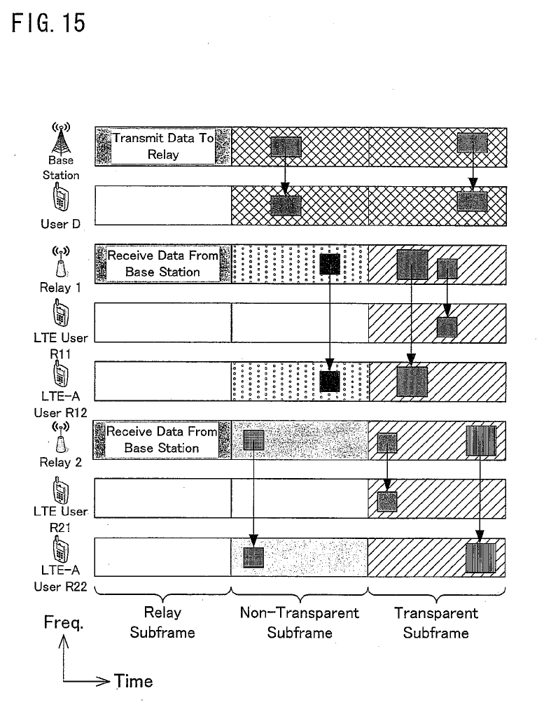

FIG. 15 illustrates a second method for allowing transparent transmission and non-transparent transmission of a relay node to coexist.

As illustrated in FIG. 15, the method base on displacement between subframes which method was used in the second method for transparent data transmission from a relay node to a user apparatus is employed, and the base station and the relay nodes can use any time-frequency resource blocks in a multiplexed manner.

The base station apparatus carries out scheduling of subframes to be used in the transparent mode and the non-transparent mode, and transmits subframe assignment information to relay user apparatuses via an upper layer signal.

The base station apparatus carries out scheduling of all relay user apparatuses which are connected with the relay nodes. In a relay subframe, the base station apparatus transmits, to all relay nodes connected with the base station apparatus, service information and control information for all the relay user apparatuses thus scheduled, by unicast, or a broadcast and/or multicast.

The base station and the relay nodes 1 and 2 use respective different operating reference signals so as to transmit data information to the LTE-Advanced relay user apparatuses R12 and R22 by use of system time frequency resource blocks in a multiplexed manner.

By use of any one of the first through third methods for allowing transparent transmission and non-transparent transmission of a relay node to coexist, the relay node 1 transmits, in a transparent subframe, data information to the LTE relay user apparatus R11 and the LTE-Advanced relay user apparatus R12, and the relay node 2 transmits, in a transparent subframe, data information to the LTE relay user apparatus R21 and the LTE-Advanced relay user apparatus R22.

According to the methods for transparent data transmission from a relay node to a user apparatus in an LTE-Advanced system and methods for allowing transparent transmission and non-transparent transmission of a relay node to coexist in an LTE-Advanced system, one relay node can transparently transmit data to an LTE relay user apparatus and non-transparently transmit data to an LTE-Advanced relay user apparatus. The methods of the present invention allow easy and effective design, and reduce complexity of system design. This makes it possible to satisfy requirements in design of an actual system and an LTE-Advanced system.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is applicable in a field of mobile communication technologies in which field a design of a transparent relay in an LTE-Advanced system and a design for coexistence of a transparent relay and a non-transparent relay in an LTE-Advanced system can be realized.

1. A method for allowing transparent transmission and non-transparent transmission of a relay node to coexist, comprising the steps of:
causing a base station apparatus to (i) schedule and arrange a carrier frequency bandwidth in which a relay node operates in a transparent mode and (ii) transmit subframe assignment information to the relay node via an upper layer signal;
causing the base station apparatus to (i) schedule all relay user apparatuses to be connected with the relay node and (ii) transmit service information and control information of all the relay user apparatuses thus scheduled, to the relay node, in a relay subframe in one carrier frequency bandwidth or in a plurality of carrier frequency bandwidths, by unicast or multicast;
causing the relay node to transmit data to an LTE relay user apparatus or an LTE-Advanced relay user apparatus in the carrier frequency bandwidth in which the relay node operates in the transparent mode; and
causing the relay node to transmit data to the LTE-Advanced relay user apparatus in a carrier frequency bandwidth in which the relay node operates in a non-transparent mode.

2. The method as set forth in claim 1, wherein carrier frequency bandwidths in which relay nodes in a cell of the base station apparatus operate in the transparent mode are perpendicular to each other.

3. A method for allowing transparent transmission and non-transparent transmission of a relay node to coexist, comprising the steps of:
causing a base station apparatus to (i) schedule a subframe to be transmitted by a relay node in a transparent mode and a subframe to be transmitted by the relay node in a non-transparent mode and (ii) transmits information on such subframe scheduling to a relay user apparatus via an upper layer signal;
causing the base station apparatus to schedule all relay user apparatuses to be connected with the relay node and transmit, in a relay subframe, service information and control information of all the relay user apparatuses thus scheduled to the relay node by unicast or multicast;
causing the relay node to transmit, in a non-transparent subframe, data to an LTE-Advanced relay user apparatus by a non-transparent method; and
causing the relay node to transmit, in a transparent subframe, data to an LTE relay user apparatus or the LTE-Advanced relay user apparatus by a transparent method.

4. A method as set forth in claim 3, further comprising the steps of:
setting a number of a subframe of the base station apparatus and a number of a subframe of the relay node so that displacement corresponding to an integer is caused between the subframe of the base station apparatus and the subframe of the relay node; and
causing the base station apparatus and the relay node to use all resource in the cell in a multiplexed manner.

5. A method for a relay node to transmit data by a transparent method, comprising the step of causing all relay nodes to transmit, in respective non-relay subframes, identical data information to one relay user apparatus by use of resource blocks which are identical in time and frequency.

6. A method as set forth in claim 5, further comprising the step of causing a base station apparatus and all relay nodes to transmit, in respective non-relay subframes, identical data information to one relay user apparatus by use of resource blocks which are identical in time and frequency.

7. The method as set forth in claim 5, wherein in a current non-relay subframe, time-frequency resource blocks which are scheduled to be transferred to respective different relay user apparatuses are perpendicular to each other.

8. A method for a relay node to transmit data by a transparent method, comprising the steps of:
causing a base station apparatus to set, in accordance with an upper layer signal, identical resource scheduling subband sets for relay user apparatuses which connect to one relay node;
causing all relay nodes to (i) transmit, in control information regions of non-relay subframes, identical control information to one relay user apparatus by use of resource blocks which are identical in time and frequency and transmit (ii) a common reference signal to the one relay user apparatus across an entire system frequency bandwidth; and
causing each of the relay nodes to transmit, in a data information region of a corresponding one of the non-relay subframes, a common reference signal, a specialized reference signal, and corresponding data information to a corresponding relay user apparatus, in a resource scheduling subband set corresponding to the corresponding relay user apparatus.

9. A method as set forth in claim 8, further comprising the step of causing relay user apparatuses to operate in a transmission mode 7 so as to demodulate data by use of a specialized reference signal applied to a predetermined antenna port.

10. The method as set forth in claim 8, wherein in a data information region of a corresponding one of the non-relay subframes, each of the relay nodes does not transmit any data information to a corresponding relay user apparatus in any subband except a resource scheduling subband set corresponding to the corresponding relay user apparatus.

11. The method as set forth in claim 8, wherein in a data information region of a corresponding one of the non-relay subframes, each of the relay nodes does not transmit any common reference signal to a corresponding relay user apparatus in any subband except a resource scheduling subband set corresponding to the corresponding relay user apparatus.

12. A method for a relay node to transmit data by a transparent method, comprising the steps of:
causing a base station apparatus to set, in accordance with an upper layer signal, identical resource scheduling subband sets for relay user apparatuses which connect to one relay node;
causing a base station apparatus to set, in accordance with an upper layer signal, identical resource scheduling subband sets for directly-connected relay user apparatuses which connect to the base station apparatus;
causing the base station apparatus and all relay nodes to (i) transmit, in control information regions of non-relay subframes, identical control information to one relay user apparatus by use of resource blocks which are identical in time and frequency and transmit (ii) a common reference signal to the one relay user apparatus across an entire system frequency bandwidth; and
causing each of base station apparatus and the relay nodes to transmit, in a data information region of a corresponding one of the non-relay subframes, a common reference signal, a specialized reference signal, and corresponding data information to a corresponding relay user apparatus, in a resource scheduling subband set corresponding to the corresponding relay user apparatus.

13. A method as set forth in claim 12, further comprising the step of causing the directly-connected relay user apparatus and the relay user apparatuses to operate in a single-antenna mode so as to demodulate data by use of a specialized reference signal applied to a predetermined antenna port.

14. The method as set forth in claim 12, wherein in a data information region of a corresponding one of the non-relay subframes, each of the base station apparatus and the relay nodes does not transmit any data information to a corresponding relay user apparatus in any subband except a resource scheduling subband set corresponding to the corresponding relay user apparatus.

15. The method as set forth in claim 12, wherein in a data information region of a corresponding one of the non-relay subframes, each of the base station apparatus and the relay nodes does not transmit any common reference signal to a corresponding relay user apparatus in any subband except a resource scheduling subband set corresponding to the corresponding relay user apparatus.

16. A method for a relay node to transmit data by a transparent method, comprising the step of causing relay nodes to transmit, at respective different carrier frequencies, data information to respective corresponding relay user apparatuses.

17. A method as set forth in claim 16, further comprising the step of causing the base station apparatus and the relay nodes to transmit, at respective different carrier frequencies, data information to respective corresponding relay user apparatuses.

18. A method for a relay user apparatus to carry out a cell search process, comprising the steps of:
detecting a carrier frequency of a system;
detecting a primary synchronization signal in a time domain so as to realize synchronization between symbols;
obtaining, in the time domain, a sector number on the basis of a sequence of the primary synchronization signal;
detecting, in the time domain, a sequence signal indicative of a physical ID of a relay node;
determining, in the time domain, a type of the relay node on the basis of a sequence of the sequence signal thus detected, in such a manner that if the sequence is a predetermined special sequence, the relay node is determined to be a transparent relay node or a base station apparatus, and if the sequence is a non-special sequence, the relay node is determined to be a non-transparent relay node;
obtaining in the time domain if the relay node has been determine to be a non-transparent relay node, a number indicated by a non-transparent relay node physical ID, on the basis of the sequence;
obtaining, in the time domain, a sub-synchronization signal so as to realize synchronization between frames;
obtaining, in the time domain, a cell group number on the basis of a sequence of the sub-synchronization signal thus detected;
determining a physical ID of a cell or the relay node in accordance with the type of the relay node;
detecting a reference signal of the relay node on the basis of the physical ID of the cell or the relay node; and
ending a cell search process so as to start a process of detecting system broadcast information.

19. A method for a relay user apparatus to carry out a cell search process, comprising the steps of:
detecting a carrier frequency of a system;
detecting a primary synchronization signal in a time domain so as to realize synchronization between symbols;
obtaining, in the time domain, a sector number on the basis of a sequence of the primary synchronization signal;
detecting, in the time domain, a sub-synchronization signal so as to realize synchronization between frames;
obtaining, in the time domain, a cell group number on the basis of a sequence of the sub-synchronization signal thus detected;
carrying out channel estimation on the basis of the sub-synchronization signal thus detected;
carrying out, on the basis of a result of the channel estimation, data demodulation of content of a symbol which is followed by a symbol containing the sub-synchronization signal;
reading a type bit of a relay node so as to determine a type of the relay node;
reading, if the type of the relay node is a non-transparent relay type, bit information indicative of a relay node physical ID;
obtaining an index number if the type of the relay node is the non-transparent relay type;
obtaining other related system information if the type of the relay node is the non-transparent relay type;
determining a physical ID of a cell or the relay node in accordance with the type of the relay node;
detecting a reference signal of the relay node on the basis of the physical ID of the cell or the relay node; and
ending a cell search process so as to start a process of detecting system broadcast information.

20. A method for a relay user apparatus to carry out a cell search process, comprising the steps of:
detecting a carrier frequency of a system;
detecting a primary synchronization signal in a time domain so as to realize synchronization between symbols;
obtaining, in the time domain, a sector number on the basis of a sequence of the primary synchronization signal;
determining, if the sequence of the primary synchronization signal is one of three sequences defined by the LTE standard which three sequences are used in transmission of the primary synchronization signal, that a node is a transparent relay node or a base station apparatus;
determining, if the sequence of the primary synchronization signal is none of the three sequences defined by the LTE standard which three sequences are used in transmission of the primary synchronization signal, that the node is a non-transparent relay node;
detecting, in the time domain, a sub-synchronization signal so as to realize synchronization between frames;
obtaining, in the time domain, a cell group number on the basis of a sequence of the sub-synchronization signal thus detected;
determining a physical ID of a cell or a relay node in accordance with the type of the node;
detecting a reference signal of the node on the basis of the physical ID of the cell or the relay node; and
ending a cell search process so as to start a process of detecting system broadcast information.

21. The method as set forth in claim 20, wherein in the step of detecting a sub-synchronization signal, the sequence thus detected is a sequence defined by the LTE standard.

22. The method as set forth in claim 1, wherein the LTE-Advanced relay user apparatus carries out a cell search process by any one of the methods recited in claims 18 to 21.

23. A relay node that carries out data transmission in a transparent mode according to claim 1.

24. A relay node that carries out data transmission in a transparent mode according to claim 3.

25. A relay node that carries out data transmission in a transparent mode according to claim 5.

26. A relay node that carries out data transmission in a transparent mode according to claim 8

27. A relay node that carries out data transmission in a transparent mode according to claim 12.

28. A relay node that carries out data transmission in a transparent mode according to claim 16.

30. An LTE-Advanced relay user apparatus that carries out a cell search process according to claim 18.

31. An LTE-Advanced relay user apparatus that carries out a cell search process according to claim 19.

32. An LTE-Advanced relay user apparatus that carries out a cell search process according to claim 20.
